(19) United States
(12) Patent Application Publication
(10) Pub. No.: US 2025/0045792 A1
(43) Pub. Date: Feb. 6, 2025

(54) Smart IoT Auto Reward Allocation

(71) Applicant: International Business Machines Corporation, Armonk, NY (US)

(72) Inventors: Hamid Majdabadi, Ottawa (CA); Jeremy R. Fox, Georgetown, TX (US); Tiberiu Suto, Franklin, NY (US); Su Liu, Austin, TX (US)

(21) Appl. No.: 18/365,707

(22) Filed: Aug. 4, 2023

(51) Int. Cl. G06Q 30/0226

(52) U.S. Cl. CPC G06Q 30/0233

(57) ABSTRACT

A computer implemented method manages a transaction. A number of processor units receives Internet of things data from a set of Internet of things sensors. The Internet of things data comprises current incentives for a group of products. The number of processor units identifies a set of transaction tokens for purchasing the group of products with a greatest benefit using the current incentives applicable to the group of products and token incentives for the transaction tokens. The number of processor units completes the transaction for the group of products using the set of transaction tokens.

### BACKGROUND

The disclosure relates generally to improved computer system and more specifically to selecting transaction tokens.

Companies and businesses employ different strategies to offer users reward and loyalty programs. For example, a coffee shop may offer a complimentary beverage as an incentive to shop at the coffee shop. Whereas credit card companies may provide cash back rewards as an incentive to use their credit cards.

A user can enroll in these programs either at the store or online, using a smartphone app or a card given at the time of purchase to accumulate points. These points can then be exchanged for a variety of rewards. These rewards include discounts, coupons, goods, services, or cash back.

Credit card reward programs can offer general points, travel points, retail credits, or cash back rewards. General points can be used to redeem goods or services, whereas travel points can be applied towards expenses such as flights, hotels, car rentals, or vacation packages. Certain reward programs may be associated with specific retail chains that offer higher points for purchases made in their stores. Cash back rewards can involve receiving a percentage of the money spent on eligible expenses. Users may have had multiple credit cards and loyalty cards providing a myriad of different incentives for using those cards in making product purchases.

### SUMMARY

According to one illustrative embodiment, a computer implemented method manages a transaction. A number of processor units receives Internet of things data from a set of Internet of things sensors. The Internet of things data comprises current incentives for a group of products. The number of processor units identifies a set of transaction tokens for purchasing the group of products with a greatest benefit using the current incentives applicable to the group of products and token incentives for the transaction tokens. The number of processor units completes the transaction for the group of products using the set of transaction tokens. According to other illustrative embodiments, a computer system and a computer program product for managing a transaction are provided.

### BRIEF DESCRIPTION OF THE DRAWINGS

FIG. 1 is a block diagram of a computing environment in which illustrative embodiments can be implemented;

FIG. 2 is a block diagram of a transaction environment in accordance with an illustrative embodiment;

FIG. 3 is an illustration of Internet of things sensors in accordance with an illustrative embodiment;

FIG. 4 is an illustration of stages in a deployment process used to create and deploy components for managing a transaction involving transaction tokens in accordance with an illustrative embodiment;

FIG. 5 is a flowchart of a process for managing a transaction in accordance with an illustrative embodiment;

FIG. 6 is a flowchart of a process for completing a transaction in accordance with an illustrative embodiment;

FIG. 7 is a flowchart of a process for completing a transaction in accordance with an illustrative embodiment;

FIG. 8 is a flowchart of process for determining a greatest benefit in accordance with an illustrative embodiment;

FIG. 9 is a flowchart of a process for simulating product purchases in accordance with an illustrative embodiment;

FIG. 10 is a flowchart of a process for simulating a transaction to purchase goods in accordance with an illustrative embodiment; and

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

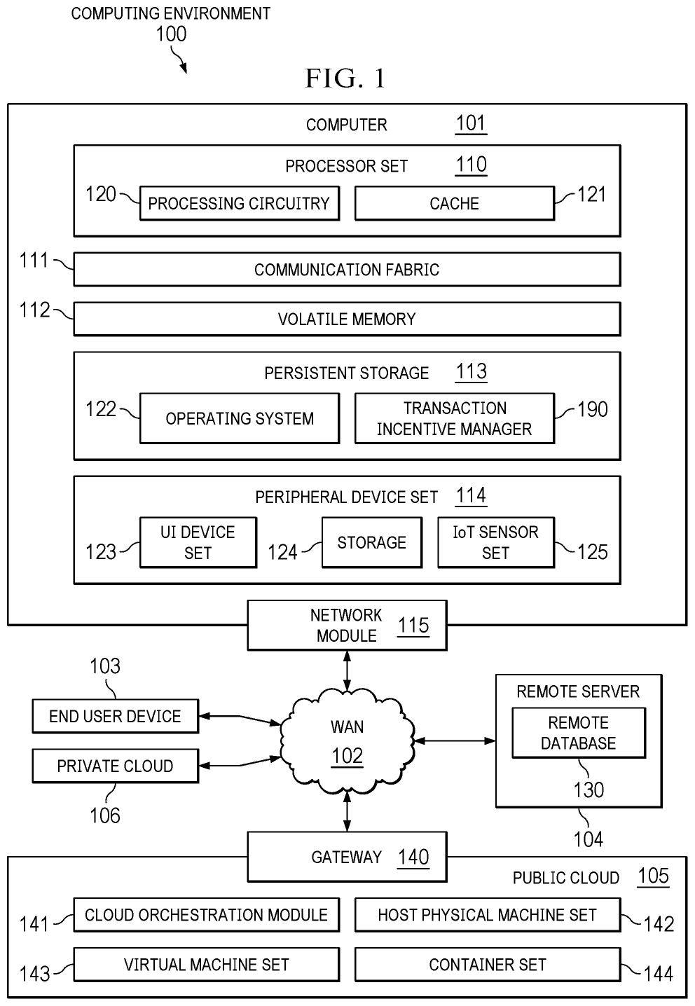

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as transaction incentive manager 190. This component can operate to manage transactions for users. This management can include managing incentives, payments involved in transactions made by users for various goods. In addition to transaction incentive manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and transaction incentive manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in transaction incentive manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in transaction incentive manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, the combination of award and loyalty programs can be confusing, especially when these programs are combined with transaction tokens such as credit cards. These illustrative examples, transaction tokens are financial tools that provide access to funds to credit. These transaction tokens can be at least one of a credit card, a debit card, a loyalty card, or other type of card. These cards can be physical or virtual cards in these examples. With so many different reward options available, it can be challenging to keep track of which rewards are associated with which card, and how to use them in combination with other rewards.

Moreover, each program may have varying rules and restrictions. These different rules and restrictions can include expiration dates, redemption limits, and blackout dates, and time-based promo codes, which can further complicate matters for customers. As a result, understanding the terms and conditions of each program thoroughly and tracking changes that may affect how consumers can earn and use their rewards is important and can be difficult when using many different programs.

To avoid confusion, some users may choose to stick to one reward program or use a dedicated app or website to manage all of their rewards in one place. Other users may opt to keep a record of their rewards and the associated cards, so they don't miss out on any potential benefits.

Further, smartphone and tablet applications are available that enable users to store all loyalty cards in one place for easy access. Some applications apps even offer access to exclusive deals and coupons from your favorite businesses, in addition to storing your reward cards. These applications may also allow you to track your rewards and record default percentage cashback.

However, these retailers or third-party provider of the applications are not totally compatible with all types of cards in consumer digital wallet and is unable to integrate other offers in plurality of media in real-time. Additionally, confusion is present about earning value versus redemption value as you may earn more points on one card, but the redemption rate might be higher. For example, one offer give 10 points on gas and other offer gives 15 points, but the 15 points cards will let the user redeem at a higher value (1 point=0.50 VS. the other one 1 point=0.75).

Further, identifying the incentives can be a daunting task. Incentives can be provided to users when traveling to a physical store. These incentives are specific to the store and may time-limited. As a result, identifying the best combination of incentives to use including current incentives received at a physical store can be a difficult and daunting task to obtain the best benefit. A similar situation can be present when a user enters an online store.

These types of incentives and others received as Internet of things data are not taken into account by applications that track and manage rewards. Further, current applications are focused on a program for a single transaction token do not take into account programs provided by other transaction tokens.

As a result, one or more illustrative examples can use Internet of things data obtained from Internet of things sensors to analyze incentives and identify combinations of transaction tokens that provide the greatest benefit to a user. The illustrative examples provide a computer implemented method, computer system, and computer program product for managing a transaction. In one illustrative example, a computer implemented method manages a transaction. A number of processor units receives Internet of things data from a set of Internet of things sensors. The Internet of things data comprises current incentives for a group of products. The number of processor units identifies a set of transaction tokens for purchasing the group of products with a greatest benefit using the current incentives applicable to the group of products and token incentives for the transaction tokens. The number of processor units completes the transaction for the group of products using the set of transaction tokens.

As used herein, a “number of” when used with reference items means one or more items. For example, a number of processor units is one or more processor units. Also as used herein, a “set of when used with reference items means one or more items. For example, a set of transaction tokens is one or more transaction tokens. In addition, as used herein, a “group of” when used with reference items means one or more items. For example, a group of products is one or more products.

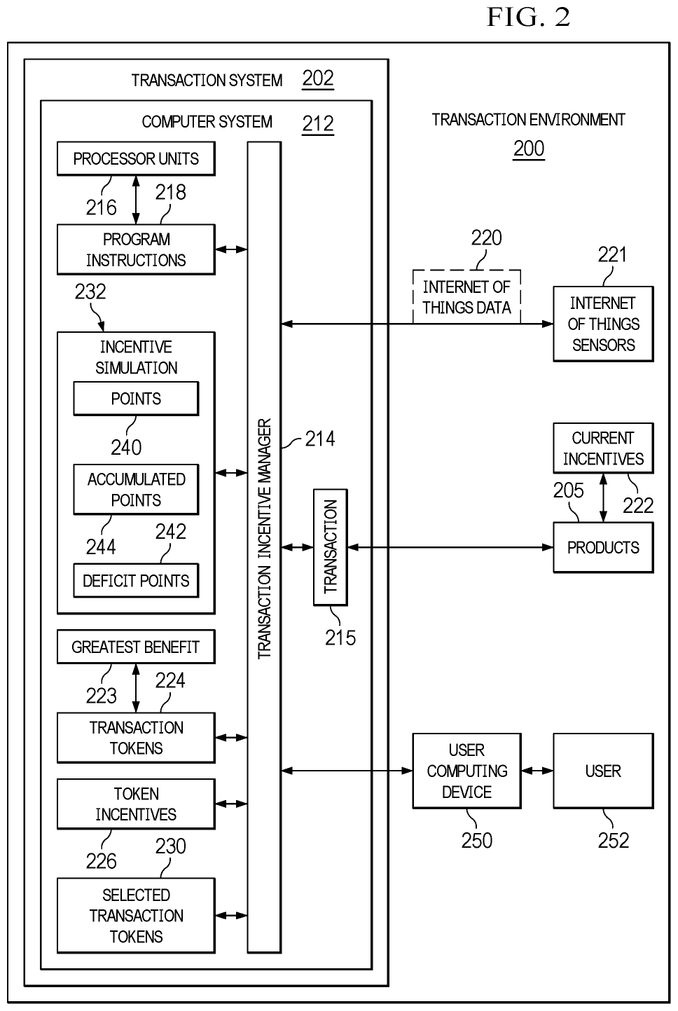

With reference now to FIG. 2, a block diagram of a transaction environment is depicted in accordance with an illustrative embodiment. In this illustrative example, transaction environment 200 includes components that can be implemented in hardware such as the hardware shown in computing environment 100 in FIG. 1. Transaction incentive manager 214 may be implemented using transaction incentive manager 190 in FIG. 1.

In this illustrative example, transaction system 202 can operate to facilitate transactions regarding products 205. Products 205 can include at least one of a good or service. A good can be a tangible item, or an intangible item. A tangible item can be, for example, a computer, a plastic container, an appliance, an automobile, or other tangible item. An intangible item can be, for example, an image, a video, software, or other item. The service is an activity or task performed.

In this illustrative example, transaction system 202 comprises computer system 212 and transaction incentive manager 214. Transaction incentive manager 214 is located in computer system 212.

Transaction incentive manager 214 can be implemented in software, hardware, firmware or a combination thereof. When software is used, the operations performed by transaction incentive manager 214 can be implemented in program instructions configured to run on hardware, such as a processor unit. When firmware is used, the operations performed by transaction incentive manager 214 can be implemented in program instructions and data and stored in persistent memory to run on a processor unit. When hardware is employed, the hardware can include circuits that operate to perform the operations in transaction incentive manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, transaction incentive manager 214 manages transaction 215 for the group of products 205. In this illustrative example, transaction incentive manager 214 can be an application, a program, a plug-in or other component. Further, transaction incentive manager 214 can be a distributed application which different components are located in different computers in computer system 212.

In this example, transaction incentive manager 214 receives Internet of things data 220 from a set of Internet of things sensors 221. Internet of things data 220 is used to identify current incentives 222 for a group of products 205. The group products 205 can be specific products of interest. In other examples, the group of products 205 can be any product within a location. This location can be a physical location such as a store, a retail outlet, a business, a market, a showroom, a supermarket, a warehouse, a showroom, a mall, a shopping center, and outlet center, a shopping complex, a market, a strip center, or other location. This location can also be virtual or online location such as a website, an application, or other virtual location for facilitating commerce.

In this example, current incentives 222 are incentives that can be used in transaction 215 to purchase one or more of products 205. In other words, current incentives 222 are incentives such as promotions, offers, or discounts that can be used or applied in transaction 215 for the group products 205.

Current incentives 222 can be identified from Internet of things data 220 selected from at least one of transaction attributes, a retailer profile, a location, a loyalty offer, an incentive, a reward, a social media feed, or other suitable types of data that can be detected by Internet of things sensors 221 relating to current incentives 222. This Internet of things data can be used to directly or indirectly determine current incentives 222. For example, the Internet of things data can include current incentives 222, identify when current incentives 222 are available based on time or location, trigger the receipt of current incentives 222, or used in other ways to identify current incentives 222 that are available or can be used.

In this example, current incentives 222 detected by Internet of things sensors 221 and included in Internet of things data 220. In this example, Internet of things sensors 221 are physical sensors or software sensors that detect information containing current incentives 222 as well as other information related to current incentives 222.

Transaction incentive manager 214 identifies a set of transaction tokens 224 for purchasing the group of products 205 with greatest benefit 223 using current incentives 222 applicable to the group of products 205 and token incentives 226 for the set of transaction tokens 224. Token incentives 226 can be incentive programs offered by each of the transaction tokens. For example, the token incentives can be a program for earning points and redeeming points for a transaction tokens. In this example, transaction incentive manager 214 can determine greatest benefit 223 using at least one of threshold milestone specific tailoring that identifies a set of incentives that have priority over other incentives, an earning value, or a redemption value.

Further, in this example, threshold milestone specific tailoring can be used in a situation in which a user has a number of specific milestones the user is trying to reach with respect to different incentives in token incentives 226. For example, the user may set a goal to earn sufficient airline miles with an airline for a vacation trip prior to booking a summer vacation trip booking while simultaneously earning car rental miles for use to rent a rental car for that same trip. With this type of threshold milestone specific tailoring, one or more particular transaction tokens in transaction tokens 224 may be given preference over other transaction tokens to obtain airline miles and car rental miles. After this goal is met, then the incentives providing greatest benefit 223 can be determined using other metrics such as earning value or redemption value.

Additionally, transaction incentive manager 214 can complete a transaction for the group of products 205 using the set of transaction tokens 224. In this illustrative example, transaction incentive manager 214 can complete transaction 215 in a number different ways. For example, transaction incentive manager 214 can automatically suggest the set of transaction tokens 224 for use in purchasing the group of products 205. Transaction incentive manager 214 can complete transaction 215 for the group of products 205 using a set of selected transaction tokens 230 in response to a user input selecting the set of selected transaction tokens 230. In this example, the selected transaction tokens 230 can be all or a portion of the set of transaction tokens 224 identified by transaction incentive manager 214.

In another example, the completion of transaction 215 can be performed by transaction incentive manager 214 to automatically pay for the group of products 205 using the set of transaction tokens 224. This automatic payment can be performed automatically depending on user preferences.

For example, user preferences can select a threshold amount for which transactions are automatically paid for using the set of transaction tokens 224. If the amount is greater than the threshold, then transaction incentive manager 214 can automatically suggest using the set of transaction tokens 224.

In this example, the suggestion of the set of token incentives 226 for automatic payment for completing transaction 215 can be made through user computing device 250 for user 252. In this example, user computing device 250 is a hardware device that includes one or more processor units. Further, user computing device 250 is a mobile device and can be, for example, a smart phone, a smartwatch, a tablet, or other suitable computing devices that can be held, worn, or carried by user 252.

In one example, the suggestion of the set of transaction tokens 224 can be displayed to user 252 on user computing device 250. In other examples, user computing device 250 can perform transaction 215 using the set of transaction tokens 224 automatically or in response to a user input by user 252.

Further, although shown as a separate component, transaction incentive manager 214 can run on user computing device 250 in some illustrative examples. In yet other illustrative examples, transaction incentive manager 214 can be a distributed application in which a portion of transaction incentive manager 214 run on user computing device 250 while another portion or portions run in other computers in computer system 212.

In another illustrative example, transaction incentive manager 214 can perform incentive simulation 232. For example, in performing incentive simulation 232, transaction incentive manager 214 can simulate purchases of a set of products 205 using points 240 without a full accumulation of points 240 needed for the set of products 205 in incentive simulation 232. With incentive simulation 232, transaction incentive manager 214 can determine deficit points 242 based on accumulated points 244 and points 240 used to purchase the set of products 205 in incentive simulation 232. In this example, depths of points 240 to represent points 240 still needed to the set of purchase products 205.

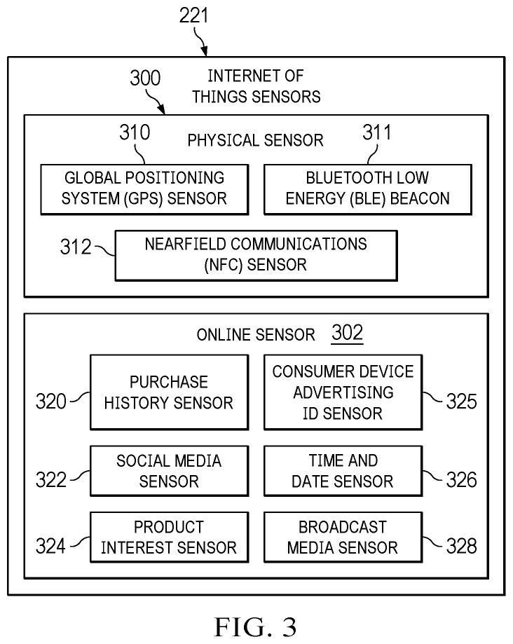

Turning next to FIG. 3, an illustration of Internet of things sensors is depicted in accordance with an illustrative embodiment. In the illustrative examples, the same reference numeral may be used in more than one figure. This reuse of a reference numeral in different figures represents the same element in the different figures.

As depicted, Internet of things sensors 221 can be implemented in a number of different ways. For example, Internet of things sensors 221 can be selected from at least one of physical sensor 300 or online sensor 302. These Internet of things sensors 221 can identify transaction attributes that can be used to determine current incentives. These transaction attributes can include, for example, at least one of a target product in transaction, retailer profile, a retail location and geo-offers, associated loyalty, offers and rewards with retailers, a real-time query of social media feeds for additional savings. This and other information can be determined using Internet of things sensors 221 as described below with respect to particular types of Internet of things sensors 221.

In this example, physical sensor 300 is a physical real world hardware devices and can be used in a store or other location where products 205 can be located. Physical sensor 300 can be, for example, global positioning system (GPS) sensor 310, Bluetooth low energy (BLE) beacon 311, and near field communications (NFC) sensor 312.

In this illustrative example, global positioning system sensor 310 is located in user computing device such as a smart phone in this example can determine the location of the user using a smart phone or other smart devices and detect when that user is close to a store, restaurant, commercial center, or other location where products 205 can be offered. The user can be considered to be close to one of these locations when the user is within some threshold distance selected for sending information to the user. Global positioning system sensor 310 generates sensor data in the form of location information about the user. This data can be used to create incentives such as targeted offers and promotions to the user's smartphone or other user computing device.

As depicted, Bluetooth low energy beacon 311 is a hardware device that broadcasts a signal to nearby smartphones. When a user enters the range of a beacon, user's smartphone can detect the signal and trigger a notification with relevant offers and promotions.

In this illustrative example, near field communications sensor 312 is a hardware device and can detect when a user taps their smartphone or loyalty card on a payment terminal. This action detected by near field communications sensor 312 can trigger a notification with current incentives such as offers and promotions that can be applied to purchase of products.

As depicted, online sensor 302 can be purchase history sensor 320, social media sensor 322, product interest sensor 324, consumer device advertising ID sensor 325, time and date sensor 326, and broadcast media sensor 328. These online sensors can be used when a user views a website or uses an app for an online store.

For example, purchase history sensor 320 can track a user's purchase history and suggest relevant offers and promotions based on the past buying behavior of the user. This sensor is a type of data analytics sensor that can track a user's purchase history and analyze user buying patterns. These buying patterns can be, for example, the types of products purchased, the frequency of purchases, and the amount spend on each purchase. Based on this data and other data, purchase history sensor 320 sensor can suggest current incentives such as relevant offers and promotions that are likely to be of interest to the user.

In this example, social media sensor 322 can monitor a user and commerce social media activity. This sensor can detect when a store or other organization shares or runs a current incentives such as a promotion on a product or service. This information can be used to send targeted offers and promotions to the user's social media account and subsequently used as input in data analytics to include in maximizing user savings during a transaction.

Product interest sensor 324 can detect when a user is browsing a particular product such as a good or service on a website and offer targeted promotions or deals for that product. In this example, consumer device advertising ID sensor 325 tracks user's interests and searches for current incentives based on those interests. Time and date sensor 326 can detect the time of day or date and offer current incentives such as promotions and deals that are relevant to that time period, such as holiday discounts or weekend sales.

In this example, broadcast media sensor 328 can be used to monitor various forms of media content, such as television, radio, social media, and billboards viewed by listened to by a user. These sensors can identify current incentives such as promotions, deals, and offers in the content and store these current inventive for use in purchasing goods.

Thus, Internet of things sensors 221 can be selected from at least one of physical sensor 300, online sensor 302, a global positioning system sensor 310, Bluetooth low energy beacon 311, near field communication sensor 312, purchase history sensor 320, social media sensor 322, product interest sensor 324, consumer device advertising

ID sensor 325, time and date sensor 326, or broadcast media sensor 328. The illustration of the different types of sensors for Internet of things sensors 221 is presented for purposes of depicting some example implementations for physical sensor 300 and online sensor 302. These illustrations are not meant to limit the manner in which other illustrative examples can be implemented.

For example, a proximity sensor to be used. A proximity sensor can detect the presence of radio frequency identification signals emitted by a user computing device such as a smart phone. In another illustrative example, the mobile phone or other user computing device can include a radio frequency identifier tag or chip that can be used to determine the proximity or presence of a user carrying the user computing device.

In one illustrative example, one or more solutions are present that overcome a problem with determining the greatest benefit for a transaction involving a group of products when multiple transaction tokens are present for use in the transaction. As a result, one or more solutions in the illustrative examples may provide an ability to determine the best benefit based on using Internet of things data to identify current incentives for a particular a group of products and to identify the set of transaction tokens for purchasing the group of products with the greatest benefit using the current incentives and the token incentives for the set of transactions. The token incentives represent incentive programs for the transaction tokens in these examples.

Computer system 212 can be configured to perform at least one of the steps, operations, or actions described in the different illustrative examples using software, hardware, firmware or a combination thereof. As a result, computer system 212 operates as a special purpose computer system in which transaction incentive manager 214 in computer system 212 enables managing a transaction for a group of products in which a set of transaction tokens identified that provide the greatest benefit to a user for the transaction. In particular, transaction incentive manager 214 transforms computer system 212 into a special purpose computer system as compared to currently available general computer systems that do not have transaction incentive manager 214.

In the illustrative example, the use of transaction incentive manager 214 in computer system 212 integrates processes into a practical application for method managing a transaction that identifies a set of transaction tokens provides a greatest benefit when taking into account current incentives and token incentives.

The illustration of transaction environment 200 in the different components in FIG. 2-3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more user computing devices in addition to user computing device 250 can be present in transaction environment 200. Internet of things data can be received for users of these user computing devices to determine combinations of transaction tokens that provide a greatest benefit or different purchases for products made by users of these user computing devices. Further, when transactions and manager 214 is a distributed component, these user computing devices can also include apps or other components for transaction incentive manager 214.

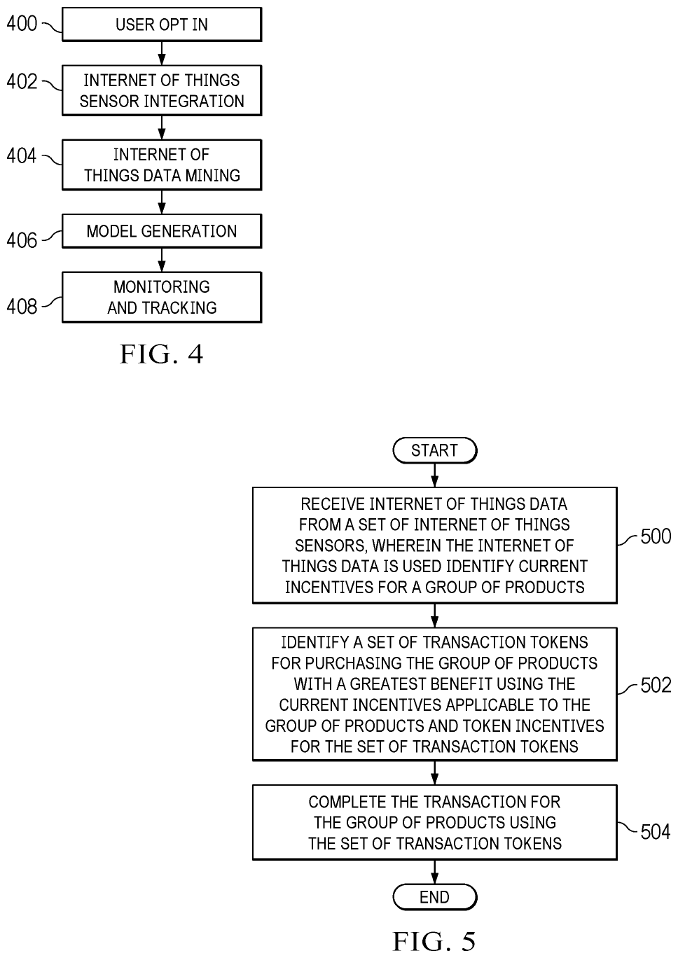

Turning next to FIG. 4, an illustration of stages in a deployment process used to create and deploy components for managing a transaction involving transaction tokens is depicted in accordance with an illustrative embodiment. The stages in FIG. 4 can be implemented in hardware, software, or both. When implemented in software, the process can take the form of program instructions that are run by one of more processor units located in one or more hardware devices in one or more computer systems. For example, the process can be implemented in transaction system 202 in FIG. 2. In this example, the stages comprise user opt in 400, Internet of things sensor integration 402, Internet of things data mining 404, model generation 406, and monitoring and tracking 408.

In user opt in 400, a user opts into using a transaction incentive manager to manage incentive tokens incentives that may be presented to the user. This transaction incentive manager can be an example of an implementation for transaction incentive manager 214 in FIG. 2. This transaction incentive manager can be implemented within an application in a smart device such as a smart phone, smart watch, tablet, or other device.

In this stage, historical purchase history, interests, and digital behavior of the user can be collected using web analytics tools. Data relating to the user's interests and behavior patterns can be analyzed using machine learning model learning techniques such as: a. clustering and classification. Clustering machine learning model techniques can include K-Means, hierarchical clustering, and other suitable clustering techniques. Classification machine learning models techniques can include decision tree, random forest and SVM. This analysis performed by the machine learning model techniques can be used to generate a personalized user profile for the user defined user interests and behavior patterns. In this example, data privacy can be enforced with protections applied to Internet of things data output. In this case, sensitive data transition can be anonymized when sent to a commerce portal.

Further, in this stage, user preferences can be set. These user preferences can be, for example, whether automatic payment is performed and when automatic payment is performed to purchase for products. Further, with respect to particular incentives for particular transaction tokens can be identified. For example, user may have a preference for airline miles. In another example, threshold milestone specific tailoring can be set to obtain specific incentives such as airline miles and hotel points within a selected period of time.

Internet of things sensor integration 402 includes implementing different types of Internet of things sensors for use in managing transaction tokens and incentives for user. These different types of Internet of things sensors can include at least one of physical sensors and online sensors as described with respect to Internet of things sensors 221 in FIG. 3.

In these examples, the Internet of things data collected from the Internet of things sensors are analyzed and cross referenced with the user settings and dependencies that can be found in the user profile created in user opt in 400. For example, this data can be used to determine whether savings for a particular incentive for a selected transaction token qualifies for a threshold set by the user to use the transaction token. As another example, user engagement with a commerce portal may indicate that the user has user has free shipping included and expiring point balance specific to a commerce portal. As a result, the use of Internet of things data can provide increased ability to identify a set of transaction tokens that provides the greatest benefit based on the current incentives available and token incentives for the transaction tokens.

Next, Internet of things data mining 404 can include steps performed using the Internet of things data sensors to collect Internet of things data. For example, steps such as data collection, data processing, and data analytics can be performed for the Internet of things data generated by Internet of things sensors.

In this stage, data collection can be performed using Internet of things sensors in Internet of things devices to collect data on spending habits, such as transaction history, purchase categories, and the time of day making purchases. These Internet of things devices include, for example, a smart phone, a smartwatch, or other device that can include Internet of things sensors to generate data for analysis. In this example, this data can be collected from credit and debit card statements, as well as loyalty program data.

The Internet of things data can be processed using machine learning algorithms to analyze the data and identify patterns in spending habits. This analysis can include identifying the categories where a user spends money, the time of day purchases are made by user, specific merchants from which the user frequently purchases products, and other suitable information. In this illustrative example, the processing of this Internet of things data can be performed prior to a user check-out such that the transaction incentive manager can have current data to apply to the user profile in selecting a set of transaction tokens for use in making purchases of products.

The analysis can be performed to create a personalized strategy for optimizing the use of multiple incentive tokens. For example, a particular credit card, loyalty card can be used along with current incentives identified using Internet of things data.

Data analysis can be performed using machine learning algorithms. These machine learning algorithms can analyze the Internet of things data and identify patterns in the user's spending behavior.

In another example, time-based promotions on cards can be integrated into the incentive transaction application into the module to maximize the benefits realized by the user. In one example, incentive tokens such as credit card A may have a special promotion on all spendings during a game day and user has a commercial transaction the same day. With this example, the transaction incentive manager detects and aggregates to identify the best card for each transaction.

In another example, an incentive token in the form of loyalty card B runs a promotion partnering with incentive tokens, such as credit card D. In this case, incentives in the form of double points can be obtained when using credit card D and loyalty card B. In these different examples, the transaction incentive manager identifies the different benefits based on the current incentives and the token incentives for different transaction tokens. This analysis can identify a set of transaction tokens that provides a greatest benefit using the current incentives applicable to the group of products and token incentives for the set of transaction tokens.

In model generation 406, a machine learning model or other type of model can be created using insights from data analysis performed in Internet of things data mining 404. For example, the insights from the data analysis can be used to create a predictive model that can recommend the best combination of incentive tokens for use any purchase. For example, the model can recommend the best credit, debit, and loyalty cards combination for a purchase. In this example, the model can also take into account the rewards structure of each card, earning versus. redemption values, and any other relevant factors, such as current promotions or special offers.

Further in this stage, this model can be implemented for use in or used by the transaction incentive manager. In this manner, the transaction set of outpatient can automatically determine on a set of transaction tokens that provide the greatest benefit each purchase of goods. Further, the transaction incentive manager can be integrated with current payment methods on various mobile payment platforms for applications to make the payment process seamless while providing the greatest benefit for purchasing products.

In monitoring and tracking 408, transaction incentive manager monitor transactions for possible missed savings or time-based opportunity to re-order in addition to communicating a final saving to the user and record that savings in a history for the user. In this example, a re-order opportunity can include transaction incentive manager considering no-fee cancellation time and continuing monitoring Internet of things data further savings that may be realized by canceling and re-ordering rather than continuing with the current transaction.

Further, transaction incentive manager can continuously monitor the model used for predictions to determine whether accurate recommendations are being made. Further, transaction incentive manager can the model through training or other adjustments as needed based on changes in user spending habits or rewards structures update and correlate them with user settings. In this stage, transaction confirmation can be performed to provide the user with a confirmation of the transaction.

The illustration of the different stages in this example are provided as one example. This illustration is not meant to limit the manner in which stages in the other illustrative examples can be implemented. For the example, different stages can be performed in parallel or different orders from the order shown in this example.

In another illustrative example, a transaction incentive manager can be implemented with a smart shopping cart. The smart shopping cart can be a physical shopping cart or an online shopping cart.

With a physical shopping cart, an Internet of things device with the transaction incentive manager can be is installed in the smart shopping cart or through a mobile app in an Internet of things device for the user. In this manner, a transaction incentive manager can be installed or otherwise associated with the shopping cart.

In this example, the transaction incentive manager can automatically scan products as a user places the products in the smart shopping cart. The scanning can be performed using various mechanisms such as a radiofrequency identifier (RFID) or barcode. The data from the scanned items can be used by the transaction incentive manager to determine the total cost of user purchases and display the information on the smart shopping cart.

Further, preferred payment methods can be implemented in the transaction incentive manager. For example, a preferred transaction token can be determined by the transaction incentive manager from available transaction tokens such as credit, debit, and loyalty cards that have been analyzed and optimized.

Additionally, automatic payment processing can be implemented using transaction incentive manager. For example, transaction incentive manager can automatically process the payment using the collection of best detected cards ensuring that the user receives the most savings possible.

Turning next to FIG. 5, a flowchart of a process for managing a transaction is depicted in accordance with an illustrative embodiment. The process in FIG. F1 can be implemented in hardware, software, or both. When implemented in software, the process can take the form of program instructions that are run by one of more processor units located in one or more hardware devices in one or more computer systems. For example, the process can be implemented in transaction incentive manager 214 in computer system 212 in FIG. 2.

The process begins by receiving Internet of things data from a set of Internet of things sensors, wherein the Internet of things data is used identify current incentives for a group of products (step 500). The process identifies a set of transaction tokens for purchasing the group of products with a greatest benefit using the current incentives applicable to the group of products and token incentives for the set of transaction tokens (step 502).

The process completes the transaction for the group of products using the set of transaction tokens (step 504). The process terminates thereafter.

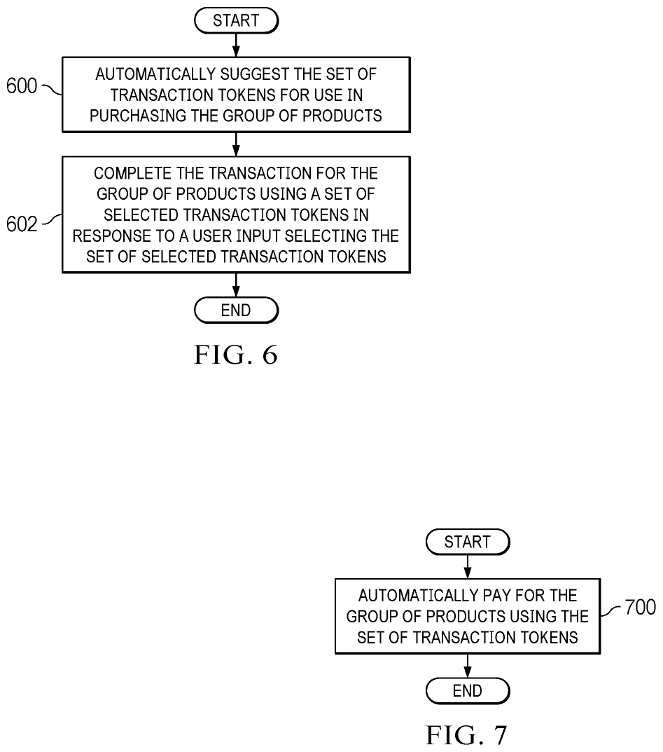

With reference now to FIG. 6, a flowchart of a process for completing a transaction is depicted in accordance with an illustrative embodiment. The process in this figure is an example of an implementation for step 504 in FIG. 5.

The process automatically suggests the set of transaction tokens for use in purchasing the group of products (step 600). The process completes the transaction for the group of products using a set of selected transaction tokens in response to a user input selecting the set of selected transaction tokens (step 602). The process terminates thereafter.

Next in FIG. 7, a flowchart of a process for completing a transaction is depicted in accordance with an illustrative embodiment. The process in this figure is an example of an implementation for step 504 in FIG. 5.

The process automatically pays for the group of products using the set of transaction tokens (step 700). The process terminates thereafter.

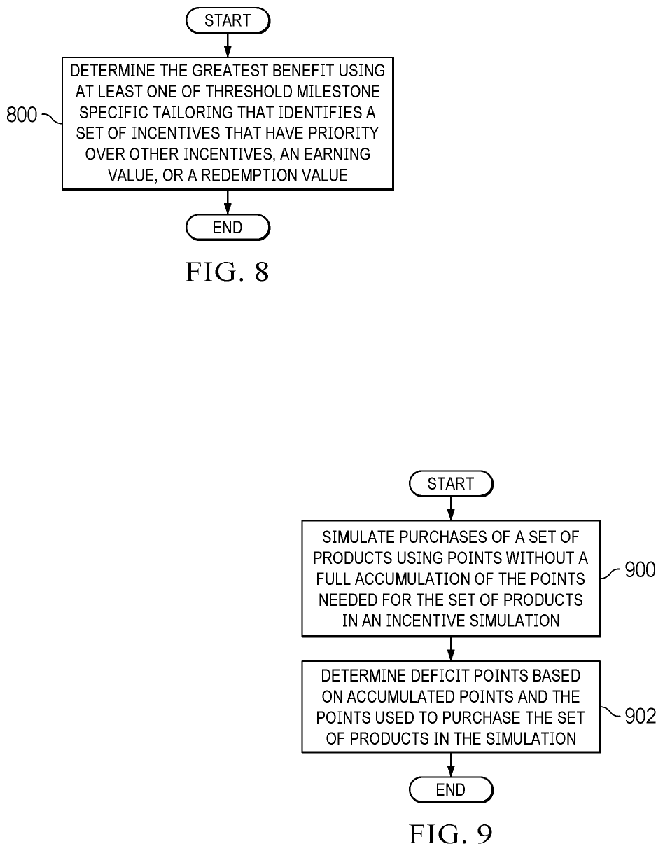

With reference now to FIG. 8, a flowchart of process for determining a greatest benefit is depicted in accordance with an illustrative embodiment. The process in this figure is an example of an additional step that can be performed in steps in FIG. 5.

The process determines the greatest benefit using at least one of threshold milestone specific tailoring that identifies a set of incentives that have priority over other incentives, an earning value, or a redemption value (step 800). The process terminates thereafter.

Turning to FIG. 9, a flowchart of a process for simulating product purchases is depicted in accordance with an illustrative embodiment. The process in this figure is an example of additional steps that can perform the process in FIG. 5.

The process simulates purchases of a set of products using points without a full accumulation of the points needed for the set of products in an incentive simulation (step 900). The process determines deficit points based on accumulated points and the points used to purchase the set of products in the simulation (step 902). The process terminates thereafter.

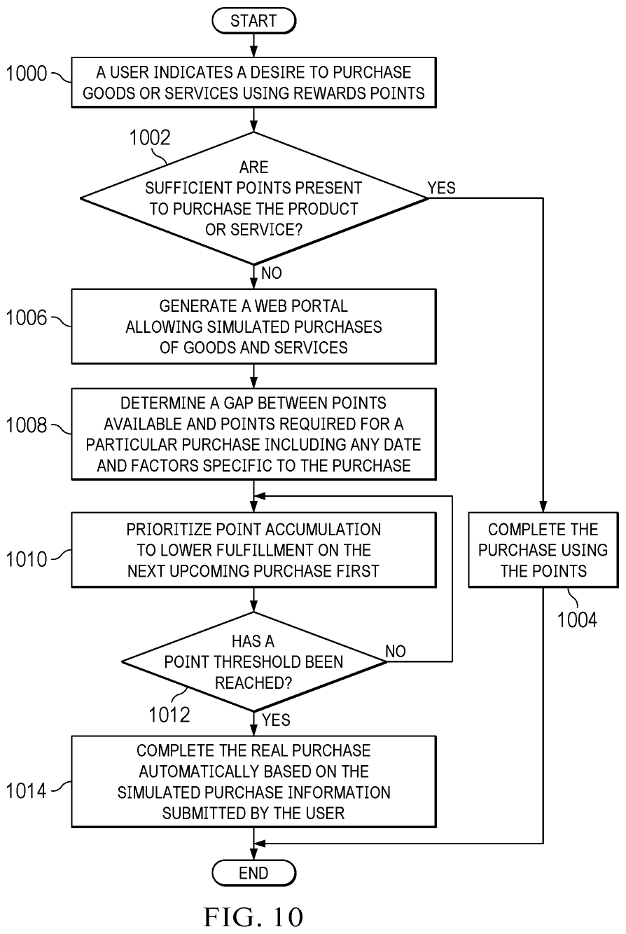

Turning next to FIG. 10, a flowchart of a process for simulating a transaction to purchase goods is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in transaction incentive manager 214 in computer system 212 in FIG. 2.

The process begins with a user indicating a desire to purchase goods or services using rewards points (step 1000). In step 1000, the indication is received as a user input and can be received by a transaction incentive manager located in a user computing device. The award points can be points earned through incentives provided by transaction tokens. These award points can be, for example, general points, airline points, hotel points, or other types points. Part of this indication can include the type of reward points needed for purchasing the goods or services. In one example, the user can indicate the number of award points desired. This number of work points is considered a point threshold in this example.

The process determines whether sufficient points are present to purchase the product or service (step 1002). If sufficient points are present, the process completes the purchase using the points (step 1004). The process terminates thereafter.

With reference again to step 1002, if sufficient points are not present, the process generates a web portal allowing simulated purchases of goods and services (step 1006). In step 1006, a web portal is a gateway or entry point to a simulated business or store that allows a simulated purchase of goods or services.

The process determines a gap between points available and points required for a particular purchase including any data and factors specific to the purchase (step 1008). The process prioritizes point accumulation to lower fulfillment on the next upcoming purchase first (step 1010). In step 1010, the process selects a transaction token or transaction tokens that provide a priority to earning the award points that the user needs for the purchase.

The process determines whether a point threshold has been reached (step 1012). In this example, the point threshold is the number of award points needed to obtain the desired points. This point threshold can be some number of award points that a user selects to redeem for a purchase such as a plane ticket, a hotel, or other item.

If the point threshold has not been reached, the process returns to step 1010. Otherwise, the process completes the real purchase automatically based on the simulated purchase information submitted by the user (step 1014). The process terminates thereafter. In step 1014, the process actually performs a simulated purchases such that the user can obtain the desired points.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

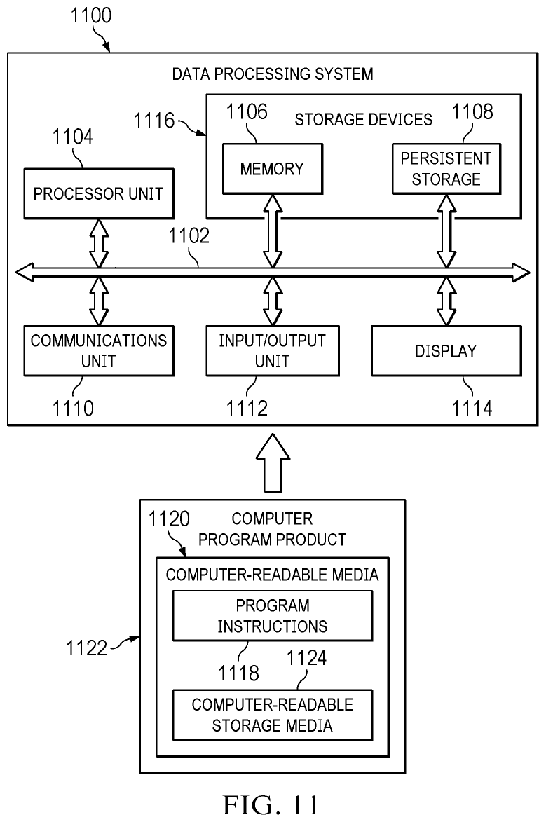

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 212 and user computing device 250 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer readable program instructions that can be read and executed by a processor in processor unit 1104. The program instructions in the different embodiments can be embodied on different physical or computer readable storage media, such as memory 1106 or persistent storage 1108.

Program instructions 1118 are located in a functional form on computer readable media 1120 that is selectively removable and can be loaded onto or transferred to data processing system 1100 for execution by processor unit 1104. Program instructions 1118 and computer readable media 1120 form computer program product 1122 in these illustrative examples. In the illustrative example, computer readable media 1120 is computer readable storage media 1124.

Computer readable storage media 1124 is a physical or tangible storage device used to store program instructions 1118 rather than a medium that propagates or transmits program instructions 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer readable signal media. The computer readable signal media are signals and can be, for example, a propagated data signal containing program instructions 1118. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1120” can be singular or plural. For example, program instructions 1118 can be located in computer readable media 1120 in the form of a single storage device or system. In another example, program instructions 1118 can be located in computer readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer readable media 1120 in a server computer while another portion of program instructions 1118 can be located in computer readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of, another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments provide a computer implemented method, computer system, and computer program product for managing a transaction. In one illustrative example, a computer implemented method manages a transaction. A number of processor units receives Internet of things data from a set of Internet of things sensors. The Internet of things data comprises current incentives for a group of products. The number of processor units identifies a set of transaction tokens for purchasing the group of products with a greatest benefit using the current incentives applicable to the group of products and token incentives for the transaction tokens. The number of processor units completes the transaction for the group of products using the set of transaction tokens.

The use of Internet of things of data enable determining the greatest benefit for purchasing products using multiple transaction tokens. The Internet of things data includes information for determining current incentives that can be applicable to group of products. This information in the Internet of things data along with token incentives for the transaction tokens can enable determining a set of transaction tokens that can be used to obtain a greatest benefit in purchasing a set of products.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing a transaction, the computer implemented method comprising:
receiving, by a number of processor units, Internet of things data from a set of Internet of things sensors, wherein the Internet of things data is used identify current incentives for a group of products;
identifying, by the number of processor units, a set of transaction tokens for purchasing the group of products with a greatest benefit using the current incentives applicable to the group of products and token incentives for the set of transaction tokens; and
completing, by the number of processor units, the transaction for the group of products using the set of transaction tokens.

2. The computer implemented method of claim 1, wherein completing, by the number of processor units, the transaction comprises:
automatically suggesting, by the number of processor units, the set of transaction tokens for use in purchasing the group of products; and
completing, by the number of processor units, the transaction for the group of products using a set of selected transaction tokens in response to a user input selecting the set of selected transaction tokens.

3. The computer implemented method of claim 1 further comprising:
automatically paying, by the number of processor units, for the group of products using the set of transaction tokens.

4. The computer implemented method of claim 1 further comprising:
determining, by the number of processor units, the greatest benefit using at least one of threshold milestone specific tailoring that identifies a set of incentives that have priority over other incentives, an earning value, or a redemption value.

5. The computer implemented method of claim 1, further comprising:
simulating, by the number of processor units, purchases of a set of products using points without a full accumulation of the points needed for the set of products in an incentive simulation; and
determining deficit points based on accumulated points and the points used to purchase the set of products in the simulation.

6. The computer implemented method of claim 1, wherein the set of IoT sensor is selected from at least one of a physical sensor, an online sensor, a global positioning system sensor, Bluetooth low energy beacon, a near field communication sensor, a purchase history sensor, a social media sensor, a product interest sensor, a consumer device advertising ID sensor, a time and date sensor, or a broadcast media sensor.

7. The computer implemented method of claim 1, wherein the Internet of Things data comprises at least one of transaction attributes, a retailer profile, a location, a loyalty offer, an incentive, a reward, or a social media feed.

8. A computer system comprising:
a number of processor units, wherein the number of processor units executes program instructions to:
receive Internet of things data from a set of Internet of things sensors, wherein the Internet of things data identifies current incentives for a group of products;
identify a set of transaction tokens for purchasing the group of products with a greatest benefit using the current incentives applicable to the group of products and token incentives for the set of transaction tokens; and
complete, by the number of processor units, a transaction for the group of products using the set of transaction tokens.

9. The computer system of claim 8, wherein as part of wherein completing, by the number of processor units, the transaction, the number of processor units further executes the program instructions to:
automatically suggest the set of transaction tokens for use in purchasing the group of products; and
complete the transaction for the group of products using a set of selected transaction tokens in response to a user input selecting the set of selected transaction tokens.

10. The computer system of claim 8, wherein as part of wherein completing, by the number of processor units, the transaction, the number of processor units further executes the program instructions to:
automatically pay for the group of products using the set of transaction tokens.

11. The computer system of claim 8, wherein the number of processor units further executes the program instructions to:
determine the greatest benefit using at least one of threshold milestone specific tailoring that identifies a set of incentives that have priority over other incentives, an earning value, or a redemption value.

12. The computer system of claim 8, wherein the number of processor units further executes the program instructions to:
simulate purchases of a set of products using points without a full accumulation of the points needed for the set of products in a simulation;
determine deficit points based on accumulated points and the points used to purchase the set of products in the simulation.

13. The computer system of claim 8, wherein the set of IoT sensor is selected from at least one of a physical sensor, an online sensor, a global positioning system sensor, Bluetooth low energy beacon, a near field communication sensor, a purchase history sensor, a social media sensor, a product interest sensor, a consumer device advertising ID sensor, a time and date sensor, or a broadcast media sensor.

14. The computer system of claim 8, wherein the Internet of Things data comprises at least one of transaction attributes, a retailer profile, a location, a loyalty offer, an incentive, a reward, or a social media feed.

15. A computer program product for managing a transaction, the computer program product comprising a computer readable storage medium having program instructions embodied therewith, the program instructions executable by a computer system to cause the computer system to:
receive Internet of things data from a set of Internet of things sensors, wherein the Internet of things data identifies current incentives for a group of products;
identify a set of transaction tokens for purchasing the group of products with a greatest benefit using the current incentives applicable to the group of products and token incentives for the set of transaction tokens; and
complete the transaction for the group of products using the set of transaction tokens.

16. The computer program product of claim 15, wherein as part of completing the transaction, the program instructions are executable by the computer system to cause the computer system to:
automatically suggest the set of transaction tokens for use in purchasing the group of products; and
complete the transaction for the group of products using a set of selected transaction tokens in response to a user input selecting the set of selected transaction tokens.

17. The computer program product of claim 15, wherein as part of completing the transaction, the program instructions are executable by the computer system to cause the computer system to:
automatically pay for the group of products using the set of transaction tokens.

18. The computer program product of claim 15, wherein the program instructions are executable by the computer system to cause the computer system to:
determine the greatest benefit using at least one of threshold milestone specific tailoring that identifies a set of incentives that have priority over other incentives, an earning value, or a redemption value.

19. The computer program product of claim 15, wherein the program instructions are executable by the computer system to cause the computer system to:
simulate purchases of a set of products using points without a full accumulation of the points needed for the set of products in a simulation; and
determine deficit points based on accumulated points and the points used to purchase the set of products in the simulation.

20. The computer program product of claim 15, wherein the set of IoT sensor is selected from at least one of a physical sensor, an online sensor, a global positioning system sensor, Bluetooth low energy beacon, a near field communication sensor, a purchase history sensor, a social media sensor, a product interest sensor, a consumer device advertising ID sensor, a time and date sensor, or a broadcast media sensor.
